(19) United States
(12) Patent Application Publication
(10) Pub. No.: US 2022/0183204 A1
(43) Pub. Date: Jun. 16, 2022

(54) DAMPER ELEMENT FOR AGRICULTURAL EQUIPMENT DISC SUPPORT, AGRICULTURAL EQUIPMENT DISC SUPPORT, AND AGRICULTURAL EQUIPMENT

(71) Applicant: Marchesan Implementos e Máquinas Agricolas Tatu S.A., Matão-SP (BR)

(72) Inventors: Sebastião Antonio Jacomine, Matão-SP (BR); Carlos Cesar Galhardi, Matão-SP (BR)

(21) Appl. No.: 17/552,777

(22) Filed: Dec. 16, 2021

(30) Foreign Application Priority Data
Dec. 16, 2020 (BR) 102020025768-4

(51) Int. Cl. A01B 61/04

(52) U.S. Cl. CPC A01B 61/044; A01B 21/086

(57) ABSTRACT

Presently described is a damping element (1) for supporting a disc (2) of agricultural equipment, the damping element (1) comprising at least one flange (10) arranged on at least one of its longitudinal ends and allowing a adequate arrangement of the damping element in the intermediary between the disc holder and the chassis of the agricultural equipment, preventing its translation or escape from the intermediary of these two parts.

### CROSS REFERENCE TO RELATED APPLICATIONS

This application claims priority to and the benefit of Brazilian Application No. 102020025768-4, filed Dec. 16, 2020; the contents of which as are hereby incorporated by reference in their entirety.

### BACKGROUND

### Technical Field

The present invention relates to a damping element, and particularly a damping element applicable to disc holders of agricultural equipment, which allows an adequate arrangement of the damping element in the intermediary between the disc holder and the chassis of the agricultural equipment, preventing its translation or escape from the intermediary of these two pieces.

### Description of Related Art

Agricultural equipment is known that make use of sets of cutting discs to prepare the soil for planting. Such assemblies of cutting discs are fixed to the chassis of the agricultural equipment, usually through holders that comprise clamps, which, in turn, are associated with support bars of the chassis of the agricultural equipment.

Usually, the association of the clamps to the chassis support bars is not carried out directly, being mediated by damping elements (similar to a stick) formed by an elastic material (generally, elastomers) that allow the absorption of impacts derived from the contact and working the cutting discs on the ground. The damping elements are generally arranged between the clamp and the support bar, contacting both these parts and ensuring that the efforts are properly transferred between both these parts through the damping elements. In this way, the impact forces felt by the discs are partially absorbed by the damping elements.

It so happens that the damping elements known in the state of the art have a purely cylindrical shape without any characteristic that allows them to be properly fixed between the clamps and the support bar. Thus, a very common problem related to the use of damping elements is the fact that, over time, due to the normal use of the equipment and the continuous vibrations felt by the damping elements, they tend to translate between the clamps and the support bar, reducing the contact surface of the damping elements with both these parts, and eventually, in extreme cases, even escaping from this intermediary, thus requiring the shutdown of the equipment for reinstallation of the damping elements.

Therefore, in the state of the art there is no damping element for a disk holder of agricultural equipment that allows an adequate arrangement/association of this element in the intermediary between the disk holder and the chassis of the agricultural equipment.

### BRIEF SUMMARY

A first objective of the present invention is to provide a damping element, particularly applicable to agricultural equipment disc holders, which allows its proper arrangement between the disc holder and the agricultural equipment chassis, preventing the translation and escape of the damping element from this intermediate.

The present invention deals with a damping element for agricultural equipment disc holders comprising at least one flange arranged on at least one of its longitudinal ends.

In one possible embodiment, the flange comprises at least one recess configured to contact a structural element of the agricultural equipment.

In another possible embodiment, the recess is a cut of flat section disposed superficially in a quadrant of the flange.

In another possible embodiment, the damping element comprises an elongated body, the longitudinal course of the body being configured to be disposed intermediate between a bracket of the disc holder and the structural element of the agricultural equipment.

In another possible embodiment, the body and flange are configured in one piece.

The present invention further deals with an agricultural equipment disc holder comprising a damping element such as the one described above in any of its possible embodiments.

The present invention further contemplates agricultural equipment comprising a disc holder and a damping element such as the one described above in any of its possible embodiments.

### BRIEF DESCRIPTION OF THE FIGURES

The present invention will be described in more detail below, based on an example of execution shown in the drawings. The figures show:

FIG. 1 is a perspective view of the damping element of the present invention in a configuration considered preferred;

FIG. 2 is a perspective view of the damping element of the present invention in a configuration considered preferred;

FIG. 3 is a side view of the damping element of the present invention in a configuration considered preferred;

FIG. 4 is a front view of the damping element of the present invention in a configuration considered preferred;

FIG. 5 is a perspective view of the disc holder of the present invention in a configuration considered preferred, and provided with the damping element of the present invention in a configuration considered preferred; and

FIG. 6 is a perspective view of the disc holder of the present invention in a configuration considered preferred, associated with a structural element of agricultural equipment, and equipped with the damping element of the present invention in a configuration considered preferred.

### DETAILED DESCRIPTION OF VARIOUS EMBODIMENTS

Initially, it should be noted that the term “preferred” used here should not be understood as imperative or mandatory, but rather to characterize an embodiment of particular efficiency of the invention among the multiple possible ones.

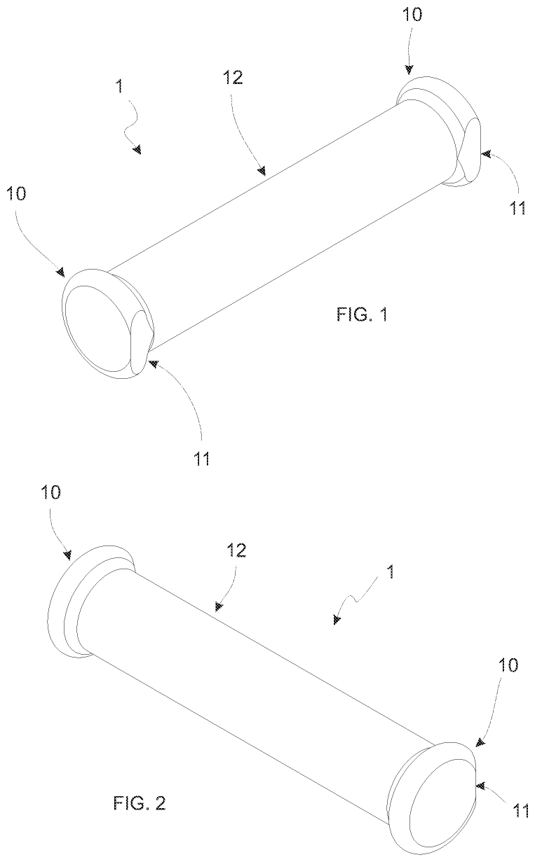

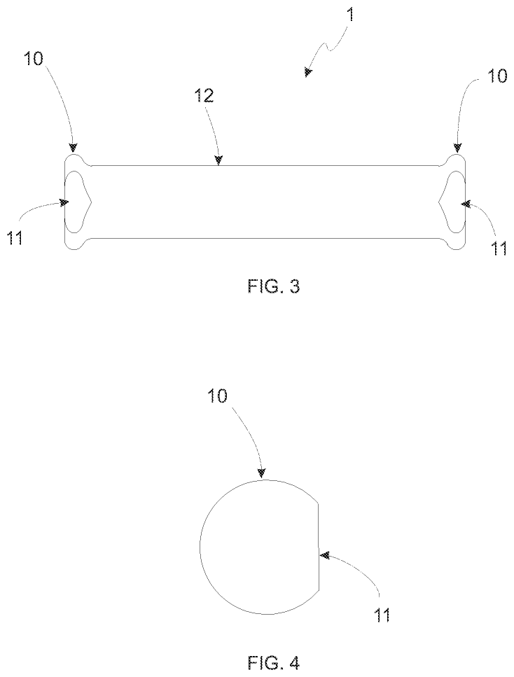

That said, FIGS. 1 to 4 reveal the damping element 1 of the present invention in a preferred embodiment. The damping element 1 comprises at least one flange 10 disposed on at least one of its longitudinal ends.

Preferably, the damping element 1 comprises a flange 10 at each of its longitudinal ends, so that its association between a disk holder 2 and a structural element 3 of the agricultural equipment is adequate and prevents its translation or spacing this intermediate by both its ends.

It is further noted that, preferably, the flange 10 of the damping element 1 comprises a circular shape. Nevertheless, the shape of the flange 10 can be any one suitable to prevent its translation with respect to the disc holder 2 and the structural element 3, such as a square or polyhedral shape, or any others.

In one possible embodiment, the flange 10 comprises at least one recess configured to contact a structural element of the agricultural equipment. Such recess 11 is intended to prevent an undesirable interference between the damping element 1 and the structural element 3 of the agricultural equipment, which would make its assembly difficult. The recess 11 can be arranged, for example, in a tangential region of the flange 10. Preferably, the recess 11 is a flat section cutoff superficially disposed in at least one quadrant of the flange 10, being more preferably disposed in a single quadrant of the flange 10.

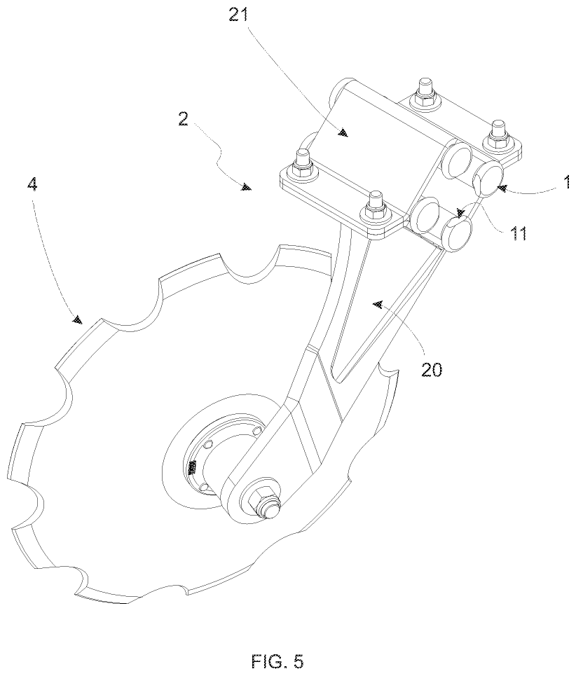

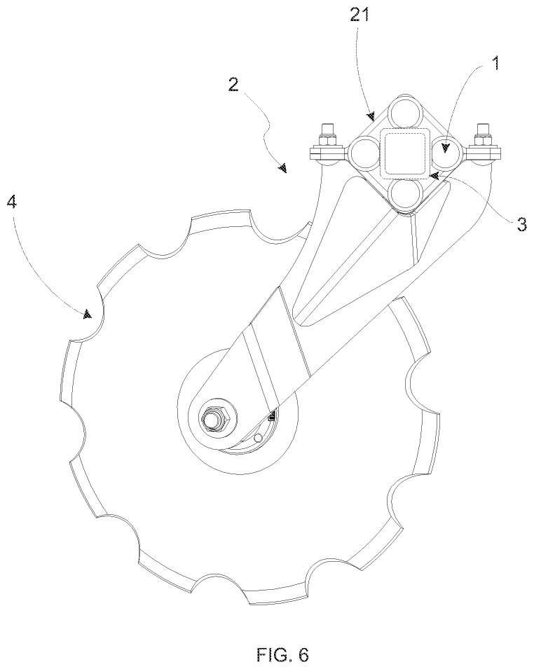

In a possible embodiment, the damping element 1 comprises an elongated body 12, the longitudinal course of the body 12 being configured to be disposed intermediate between a bracket 21 of the disc holder 2 and the structural element 3 of the agricultural equipment. This arrangement can be seen, for example, in FIGS. 5 and 6, where it is seen that the damping element 1 is arranged between a clamp 21 of the disc holder 2 and a structural element 3 of the agricultural equipment. Preferably, the body 12 is integral with the flange 11, i.e. they are configured in one piece, so that the damping element 1 can be practically and inexpensively manufactured in a single step, for example a single step for elastomer thermoplastic shaping.

By way of clarification, the structural element 3 of the agricultural equipment can be, for example, a support bar used to support the disc holder 2 and, consequently, the disc 4. Said support bar can be, for example, a square section profile, such that, in this specific arrangement, a set of four damping elements 1 are used to contact each surface of the structural element 3 in order to provide fastening and absorption of efforts between the disc holder 2 and the structural element 3, as best seen in FIG. 6.

To better clarify the interaction between the damping element 1, the disc holder 2 and the structural element 3, attention is drawn to FIG. 6, where the complete assembly of these three elements is observed. The damping element 1 is disposed between, or in between, the disc holder 2 and the structural element 3. More specifically, the damping element is arranged between an apex of the clamp 21 and a flat surface of the structural element 3, so that the vibration and impact stresses coming from the disc 4 and transferred to the clamp 21 by the arm 20 of the disc holder 2 are at least partially absorbed by damping element 1. Through the presence of flanges 10 on the damping element 1, said flanges 10 prevent the damping element 1 from translating with respect to the disc holder 2 as said flanges 10 collide with the clamp 21 during a potential movement of the damping element 1.

In this way, the damping element 1 of the present invention allows an adequate arrangement of itself in the intermediary between the disc holder 2 and the structural element 2 of the agricultural equipment, as it is able to prevent its own translation and escape of this intermediary by the presence of the flanges 10. Thus, the damping element 1 eliminates the need to stop the equipment to adjust its positioning, or even to refit it in the disc holder 2.

The present invention further contemplates a disc holder 2 comprising the damping element 1 above described in any of its embodiments, and agricultural equipment comprising the disc holder 2 and the damping element 1 above described in any of its embodiments.

Having described an example of preferred embodiment, it should be understood that the scope of the present invention encompasses other possible variations, being limited solely by the content of the appended claims, including possible equivalents therein.

1-7. (canceled)

8. A damping element (1) for a disc holder (2) of agricultural equipment, the damping element (1) comprising at least one flange (10) arranged on at least one of its longitudinal ends.

9. The damping element (1) according to claim 8, wherein the flange (10) comprises at least one recess (11) configured to contact a structural element (3) of agricultural equipment.

10. The damping element (1) according to claim 9, wherein the recess (11) is a flat section cutoff superficially disposed in a quadrant of the flange (10).

11. The damping element (1) according to claim 9, further comprising an elongated body (12), the longitudinal course of the body (12) being configured to be arranged in the intermediary between a clamp (21) of the disc holder (2) and the structural element (3) of the agricultural equipment.

12. The damping element (1) according to claim 11, wherein the body (12) and the flange (10) are configured in one piece.

13. A disc holder (2) of agricultural equipment, the disc holder comprising the damping element (1) of claim 8.

14. Agricultural equipment comprising the disc holder (2) according to claim 13.
